(19) United States
(12) Patent Application Publication
(10) Pub. No.: US 2021/0163119 A1
(43) Pub. Date: Jun. 3, 2021

(54) WING ROOT POSITIONED AT THE BACK AND BEHIND THE BACK OF AIRCRAFT AND SPACECRAFT RELATED VEHICLES OR PROPELLED/PROJECTILE OBJECTS TO REDUCE DRAG

(71) Applicant: Taylor DiAnte' Brown, Jackson, MS (US)

(72) Inventor: Taylor DiAnte' Brown, Jackson, MS (US)

(21) Appl. No.: 17/095,160

(22) Filed: Feb. 24, 2021

Related U.S. Application Data
(60) Provisional application No. 62/934,752, filed on Nov. 13, 2019.

(51) Int. Cl. B64C 3/14; B64G 1/14

(52) U.S. Cl. CPC B64C 3/14; B64C 2003/147; B64G 1/14

(57) ABSTRACT

Repositioning the wing provides a methodology in reducing drag on multiple types of vehicles and objects. When the wing's root chord trailing edge is positioned further towards the back of the fuselage, it produces less drag. Therefore, aerospace vehicles or objects may benefit from this in reducing fuel consumption.

### BACKGROUND OF THE INVENTION

Birds have always been aerodynamically efficient. Through examining the shape of bird wings and tails, we have been able to learn how they maintain flight. In ways, we have created our own versions of these wings or tails so we can achieve flight with our aircrafts. The main forces that act on an aircraft are lift and drag. Lift sustains an aircraft in the air while drag pushes against the aircraft as a consequence of the aircraft moving forward. There have been different methodologies in reducing drag and increasing lift on aircraft by changing the shape of the wings and tails. However, in the case of wings, forces on an aircraft can be affected by also changing the location of them.

This invention is to be applied in the field of fluid mechanics. This invention targets making a vehicle or object more streamlined and therefore reducing drag and increasing stability. An aircraft produces less drag if the wing is moved further back. This entails the wing's root trailing edge being at the back or behind the fuselage. The less drag an aircraft produces, the more stable it becomes. As the wing's root leading edge moves further away after the nose of the aircraft, the aircraft can produce less drag and becomes more stable.

### BRIEF SUMMARY OF THE INVENTION

Most vehicles and objects that consist of wings, have them being positioned towards the back. However, this invention promotes moving the wing further back and as far as it can go to become more streamlined. By moving the wing's root leading edge back, it reduces drag.

### BRIEF DESCRIPTION OF THE DRAWINGS

FIG. 1A-FIG. 1A displays the front view of the aircraft. FIG. 1A displays the number 1 pointing to one out of two wings on the aircraft whose root trailing edge is even to the fuselage trailing edge.

FIG. 1B-FIG. 1B displays the top view of the aircraft. FIG. 1B displays the number 2 pointing to the area where the wing's root trailing edge is attached and even to the trailing edge of the fuselage. The number 2 in FIG. 1B corresponds to the number 1 in FIG. 1A. The curve line with two slanted lines intersecting its middle on the left wing or left side of the figure denotes the end point of interest of the aircraft.

FIG. 1C-FIG. 1C displays the side view of the aircraft. FIG. 1C displays the number 3 pointing to the wing root trailing edge being attached and even with the trailing edge of the fuselage. This wing is the side view of the wing that is denoted in FIG. 1A as number 1 and FIG. 1B as number 2.

FIG. 2A-FIG. 2A displays the front view of the aircraft. FIG. 2A displays the number 4 pointing to one out of two wings on the aircraft whose root trailing edge is behind the fuselage trailing edge.

FIG. 2B-FIG. 2B displays the top view of the aircraft. FIG. 2B displays the number 5 pointing to where the fuselage trailing edge ends. The number 6 in FIG. 2B points to where the wing trailing edge root ends, which is behind the fuselage trailing edge. This wing is the same as the wing denoted as number 4 in FIG. 2A. The curve line with two slanted lines intersecting its middle on the left wing or left side of the figure denotes the end point of interest of the aircraft.

FIG. 2C-FIG. 2C displays the side view of the aircraft. FIG. 2C displays the number 7 pointing to where the fuselage trailing edge ends, which is also denoted as number 5 in FIG. 2B. The number 8 in FIG. 2C points to where the wing trailing edge root ends, which is behind the fuselage trailing edge. This wing is the same as the wing denoted as number 4 in FIG. 2A and number 6 in FIG. 2B.

### DETAILED DESCRIPTION OF THE INVENTION

The terminology within this section is used for describing the characteristics, functionality, and uses thereof. The term “and/or” used within a sentence denotes any and all combinations of one or more of the associated listed elements. The singular forms of “a,” “an,” and “the” are also intended to include the plural forms unless otherwise stated. It is presumed that scientific, technical, engineering, and mathematical terms are universally defined. It is further understood that these definitions are not limited to their common definitions and may be found through the use of dictionaries or other sources.

There are multiple types of vehicles and objects that can utilize this invention such as: an aircraft, spacecraft, propelled object, and projectile object. The following definitions of an aircraft, spacecraft, propelled object, and projectile object are simply defined, and are not limited to these definitions. An aircraft is any vehicle made to fly within the Earth's atmosphere. A spacecraft is any vehicle made to exit the Earth's atmosphere. A propelled object is any object that has a propulsion system to propel the object in a designated direction. A projectile object is any object that has the capability of being launched from a person's hand or a platform.

The wings on a vehicle or object sustain it in flight. Depending on how the wings are shaped can affect how streamlined a vehicle or object is while also affecting lift and drag. Streamlined is defined as but not limited to, a shape of a vehicle or object that is resistant to drag. Lift is defined as but not limited to, the force that sustains the vehicle or object in air. Drag is the opposing force operating on the surface of a vehicle or object while it is in travel. This invention entails changing the location of where the wings' root leading edge is and/or where the wing root come out of the body of the vehicle or object to make it more streamlined. “Come out of the body” or “coming out of the body” describes the location where the root or base of the wing is connected to the main body of the vehicle or object. The root is defined as but not limited to, the part that connects to the body of a vehicle or object.

For example, in using the older wing configurations of an aircraft, the wings may come out of the body in the back region, but not being all the way at the back. “Older” describes the root of the wing configurations coming out of the back region, but not having its root trailing edge at the fuselage trailing edge and/or the root trailing edge behind the fuselage. The wing's root leading edge is the backmost part of the wing that is closest to the axis of symmetry and/or the axis corresponding to the center of rotation of the vehicle's or object's main body and/or fuselage. “Behind” describes the wing's root trailing edge being even to the back of the fuselage of a vehicle or object, and/or describes the wing's root trailing edge being the backmost part of the aircraft. In applying the invention, if the wing's root come out of the body at the back of the fuselage, it can reduce drag. Also, if the wing's root leading edge is behind the fuselage, it can reduce drag.

It is important to note that there are some airplanes that have their wings' root at the back. However, this may be because of other reasons instead of specifically to become more streamlined and reduce drag. If a vehicle or object reduces drag and/or becomes more stable as a result of becoming streamlined, then this describes the invention. This invention describes all wing configuration designs that have their root trailing edge located at the fuselage trailing edge and/or root trailing edge behind the fuselage to become more streamlined and reduce drag. This invention also describes putting the wings as far back as possible on a vehicle or object. “As far back as possible” describes the vehicle's and/or object's ability to be at the backmost part, as this may vary.

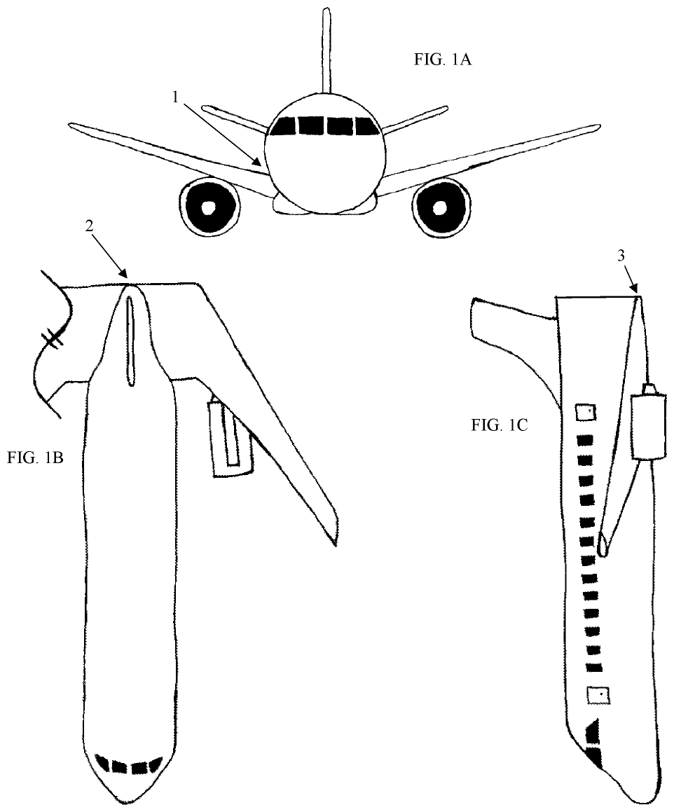

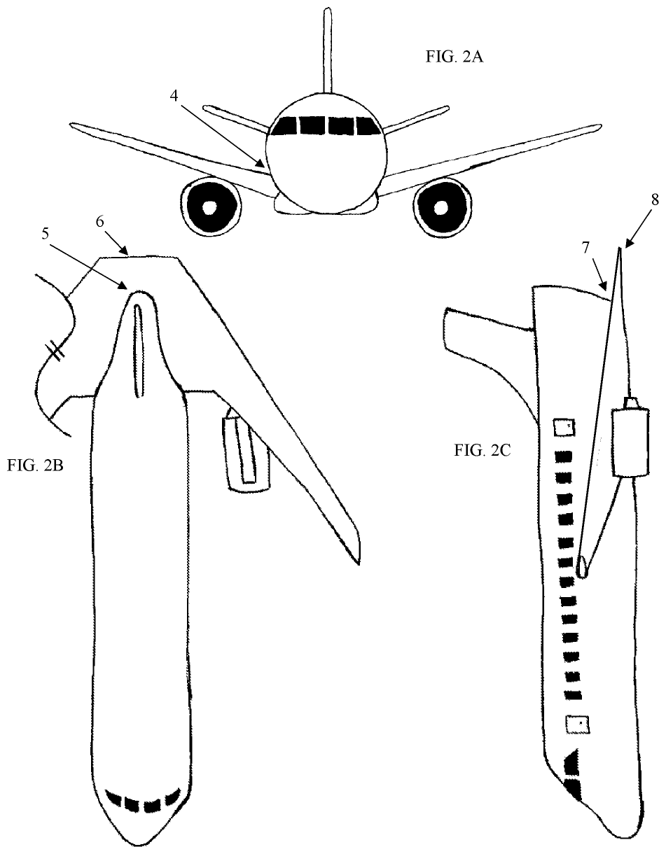

FIGS. 1A, 1B, and 1C display examples of the trailing edge of wing roots being located at the back of an aircraft. FIGS. 2A, 2B, and 2C display examples of the trailing edge of wing roots located behind the fuselage of an aircraft. It is presumed that these figures do not limit the scope or usefulness of the invention. For example, there can be different vehicles or objects with different wing shapes and different number of wings.

FIG. 1A displays the front view of the aircraft. FIG. 1A displays the number 1 pointing to one out of two wings on the aircraft whose root trailing edge is even to the fuselage trailing edge. FIG. 1B displays the top view of the aircraft. FIG. 1B displays the number 2 pointing to the area where the wing's root trailing edge is attached and even to the trailing edge of the fuselage. The number 2 in FIG. 1B corresponds to the number 1 in FIG. 1A. The curve line with two slanted lines intersecting its middle on the left wing or left side of the figure denotes the end point of interest of the aircraft. FIG. 1C displays the side view of the aircraft. FIG. 1C displays the number 3 pointing to the wing root trailing edge being attached and even with the trailing edge of the fuselage. This wing is the side view of the wing that is denoted in FIG. 1A as number 1 and FIG. 1B as number 2.

FIG. 2A displays the front view of the aircraft. FIG. 2A displays the number 4 pointing to one out of two wings on the aircraft whose root trailing edge is behind the fuselage trailing edge. FIG. 2B displays the top view of the aircraft. FIG. 2B displays the number 5 pointing to where the fuselage trailing edge ends. The number 6 in FIG. 2B points to where the wing trailing edge root ends, which is behind the fuselage trailing edge. This wing is the same as the wing denoted as number 4 in FIG. 2A. The curve line with two slanted lines intersecting its middle on the left wing or left side of the figure denotes the end point of interest of the aircraft. FIG. 2C displays the side view of the aircraft. FIG. 2C displays the number 7 pointing to where the fuselage trailing edge ends, which is also denoted as number 5 in FIG. 2B. The number 8 in FIG. 2C points to where the wing trailing edge root ends, which is behind the fuselage trailing edge. This wing is the same as the wing denoted as number 4 in FIG. 2A and number 6 in FIG. 2B. It is presumed that the processes, manufacturability, and assembly of these wing configurations on the body of the aircraft, spacecraft, propelled object, or projectile object should follow the same or similar guidelines in how the older designs of wing configurations for vehicles and objects are made.

The claimed invention is:

1. Aircraft or spacecraft comprising of a wing's root chord trailing edge originating from the trailing edge of the fuselage or a wing's root chord trailing edge originating from behind the trailing edge of the fuselage.
